(19) United States
(12) Patent Application Publication
(10) Pub. No.: US 2011/0179719 A1
(43) Pub. Date: Jul. 28, 2011

(54) BACK DOOR STRUCTURE OF VEHICLE

(75) Inventors: Koichi MATSUMOTO, Hiroshima (JP); Kouji FUJIKAWA, Hiroshima (JP)

(73) Assignee: MAZDA MOTOR CORPORATION, Hiroshima (JP)

(21) Appl. No.: 12/978,003

(22) Filed: Dec. 23, 2010

(30) Foreign Application Priority Data
Jan. 25, 2010 (JP) 2010-013000

(51) Int. Cl. B60J 5/10

(52) U.S. Cl. 49/502; 49/501

(57) ABSTRACT

A back door structure of a vehicle comprises an inner panel and an outer panel of a back door, a latch provided at a central portion, in a vehicle width direction, of a lower side portion of the back door, a latch opening portion formed at a latch attachment portion of the lower side portion, a reinforcing member provided at the lower side portion, the reinforcing member reinforcing a periphery of the latch opening portion, and side wall portions provided on both sides of the reinforcing member, in the vehicle width direction, the side wall portions extending in a vehicle longitudinal direction between the inner and outer panels of the back door and connecting the inner panel to the outer panel.

### BACKGROUND OF THE INVENTION

The present invention relates to a back door structure of a vehicle, and in particular, relates to a back door structure of a vehicle in which a back door comprises an inner panel and an outer panel, and the inner panel of the back door comprises an upper side portion which forms an upper side of a window opening portion, upper side portions which extend downwardly from both sides of the upper side portion, and a lower half portion which connects to both lower ends of the upper side portions.

In general, in vehicles, such as a wagon type of vehicle, an opening portion is formed at a rear wall of a vehicle body, and a back door is provided to open or close the opening portion. The back door is closed and locked by a striker provided on a vehicle-body side and a latch provided on a back-door side. Herein, while the vehicle travels, harshness of a road surface is inputted via vehicle tires as outer vibrations. Therefore, in order to prevent an occurrence of noises from the back door which may be caused by the outer vibrations, it is desired that a lower portion of the back door has a sufficient rigidity.

In view of the above-described desire, a back door structure of a vehicle disclosed in Japanese Patent Laid-Open Publication No. 2009-23480 has been proposed. According to this back door structure, a back door rotates around a hinge provided at an upper side portion of a rear vehicle body to open or close an opening portion formed at a rear face of the vehicle body. The back door comprises an inner panel and an outer panel and is made as a hollow body. An opening portion of a latch which is provided on a back-door side and engages with a striker on a vehicle-body side when the back door is closed is formed at a lower face portion of the inner panel. The latch is attached to the lower face portion of the inner panel via a reinforcing plate to reinforce a periphery of the latch opening portion of the inner panel. The reinforcing member has an upward extension portion which extends upwardly from its rear portion and is joined to the outer panel, and the inner panel is joined to the upward extension portion.

According to the above-described conventional structure disclosed in the patent publication, the rigidity of the lower face portion of the inner panel improves, so that its deformation can be prevented and thereby vibrations and noises can be restrained to a certain degree. However, since the width, in a vehicle width direction, of the above-described upper extension portion is rather small, the above-described restraint of occurrence of vibrations and noises is insufficient.

### SUMMARY OF THE INVENTION

An object of the present invention is to provide a back door structure of a vehicle which secures the sufficient rigidity so that vibrations and noises can be restrained properly.

According to the present invention, there is provided a back door structure of a vehicle, comprising an inner panel of a back door, an outer panel of the back door, a latch provided at a central portion, in a vehicle width direction, of a lower side portion of the back door, a latch opening portion formed at a latch attachment portion of the lower side portion of the back door, a reinforcing member provided at the lower side portion of the back door; the reinforcing member reinforcing a periphery of the latch opening portion, and a side wall portion provided on a side of the reinforcing member, in the vehicle width direction, the side wall portion extending in a vehicle longitudinal direction between the inner and outer panels of the back door and connecting the inner panel to the outer panel.

According to the present invention, the sufficient rigidity can be secured by the above-described side wall portion, so that the vibrations and noises can be restrained properly.

According to an embodiment of the present invention, the side wall portion comprises a pair of side wall portions which is provided on both sides of the reinforcing member so that the latch opening portion is positioned therebetween. Thereby, the above-described securing the sufficient rigidity can be properly achieved.

According to another embodiment of the present invention, each of the side wall portions includes an inner-panel-side joint flange and an outer-panel-side joint flange, the inner-panel-side joint flange bending inwardly in the vehicle width direction, the outer-panel-side joint flange bending outwardly in the vehicle width direction. Thereby, the side wall portions can be firmly joined to the inner panel with a properly short span in the vehicle width direction, and the side wall portions can be widely joined to the outer panel with a properly wide span in the vehicle width direction.

According to another embodiment of the present invention, the side wall portions are configured so that a distance therebetween, in the vehicle width direction, becomes greater toward the outer panel of the back door in a plan view. Thereby, the side wall portions can be widely joined to the outer panel with a wide span.

According to another embodiment of the present invention, the side wall portions are configured so that a distance therebetween, in the vehicle width direction, becomes greater upwardly in an elevation view. Thereby, the side wall portions can be widely joined to a properly-upper portion of the outer panel with a wide span.

According to another embodiment of the present invention, the outer-panel-side joint portions of the side wall portions are joined by welding to the outer panel of the back door at specified positions which correspond to an exterior component provided at an outside face of the outer panel. Herein, the above-described exterior component may be comprised of a license plate. Thereby, the sufficiently firm joint can be secured by welding of the outer-panel-side joint portions of the side wall portions to the outer panel, and since these welding points are covered with the exterior component, good appearances may not be deteriorated. Accordingly, securing both the rigidity and the good appearances can be achieved.

According to another embodiment of the present invention, the inner panel of the back door comprises an upper side portion which forms an upper side of a window opening portion, upper side portions which extend downwardly from both sides of the upper side portion, and a lower half portion which connects to both lower ends of the upper side portions, and the lower half portion of the inner panel includes a middle side portion which forms a lower side of the window opening portion at a middle position, in a vehicle vertical direction, of the back door, the above-described lower side portion which forms a lower side of the back door, an opening portion which is formed between the middle side portion and the lower side portion, lower side portions which are provided on both sides of the opening portion, and slant portions which connect joint portions between the middle side portion and the lower side portions to the lower side portion, each of the slant portions extending obliquely in an elevation view. Thereby, the weight of the back door can be properly light by forming the opening portion at the lower half portion of the inner panel, and the sufficient rigidity can be secured by the above-described slant portions and reinforcing member at the latch attachment portion, so that the vibrations and noises can be restrained properly. Accordingly, both the light weight of the back door and the restraint of vibrations and noises can be achieved.

According to another embodiment of the present invention, the middle side portion of the lower half portion of the inner panel has joint portions which extend toward the outer panel and are joined to the outer panel at a central portion thereof in the vehicle width direction. Thereby, since the above-described joint portions join the middle side portion of the inner panel to the outer panel, the sufficient rigidity of the middle side portion can be secured, so that the vibrations and noises can be restrained properly.

According to another embodiment of the present invention, the slant portions of the lower half portion of the inner panel have joint portions which extend toward the outer panel and are joined to the outer panel. Thereby, since the above-described joint portions join the slant portions of the inner panel to the outer panel, the sufficient rigidity of the slant portions can be secured, so that the vibrations and noises can be restrained properly.

According to another embodiment of the present invention, the joint portions of the middle side portion of the lower half portion and/or the joint portions of the slant portions are arranged substantially horizontally in the vehicle width direction. Thereby, the outer panel and the middle side portion, or the outer panel and slant portions are joined via the joint portions arranged substantially horizontally, so that securing the sufficient rigidity can be achieved efficiently.

According to another embodiment of the present invention, the joint portions are joined to the outer panel by welding, and an exterior component is provided at an outside face of the outer panel. Herein, the above-described exterior component may be comprised of a garnish or a license plate. Thereby, the sufficiently firm joint can be secured by welding of the above-described joint portions to the outer panel, and since welding points are covered with the exterior component, good appearances may not be deteriorated. Accordingly, securing both the rigidity and the good appearances can be achieved.

According to another embodiment of the present invention, the lower half portion of the inner panel further includes connection portions which connect respective middle portions of the slant portions to the above-described lower side portions or the above-described lower side portion. Thereby, since the slant portions are connected to the lower side portions or the lower side portion via the connection portions, the sufficient rigidity of the slant portions can be secured, so that the vibrations and noises can be restrained properly.

Other features, aspects, and advantages of the present invention will become apparent from the following description which refers to the accompanying drawings.

### BRIEF DESCRIPTION OF THE DRAWINGS

FIG. 1 is a back view showing a back door structure of a vehicle according an embodiment of the present invention.

FIG. 2 is a back view of an inner panel.

FIG. 3 is a perspective view of the inner panel.

FIG. 4 is a sectional view taken along line A-A of FIG. 1.

FIG. 5 is a back view of a reinforcing member.

FIG. 6 is a plan view of the reinforcing member.

FIG. 7 is a left side view of FIG. 6.

FIG. 8 is a right side view of FIG. 6.

FIG. 9 is a perspective view of the reinforcing member.

FIG. 10 is a perspective view showing a reinforcement structure by the reinforcing member.

FIG. 11 is an enlarged sectional view taken along line B-B of FIG. 2.

FIG. 12 is a perspective view showing a modified reinforcing member.

### DETAILED DESCRIPTION OF THE INVENTION

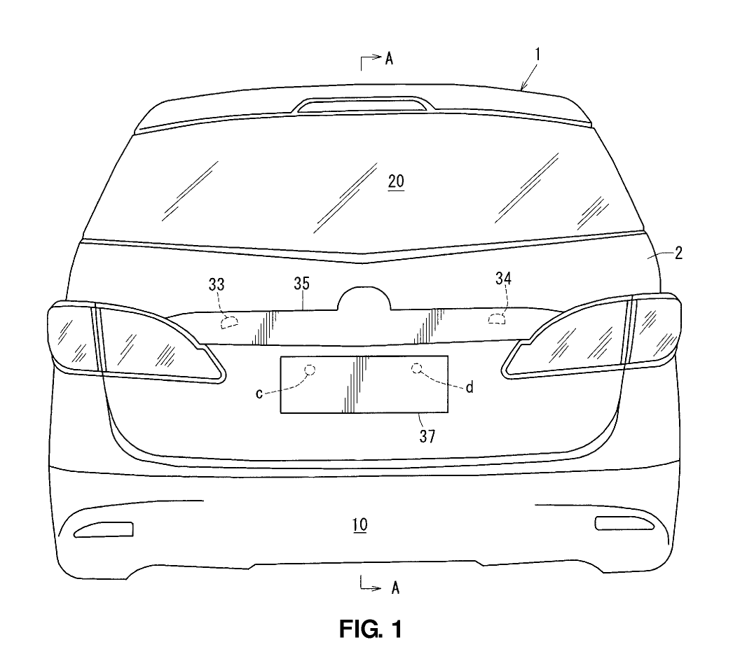

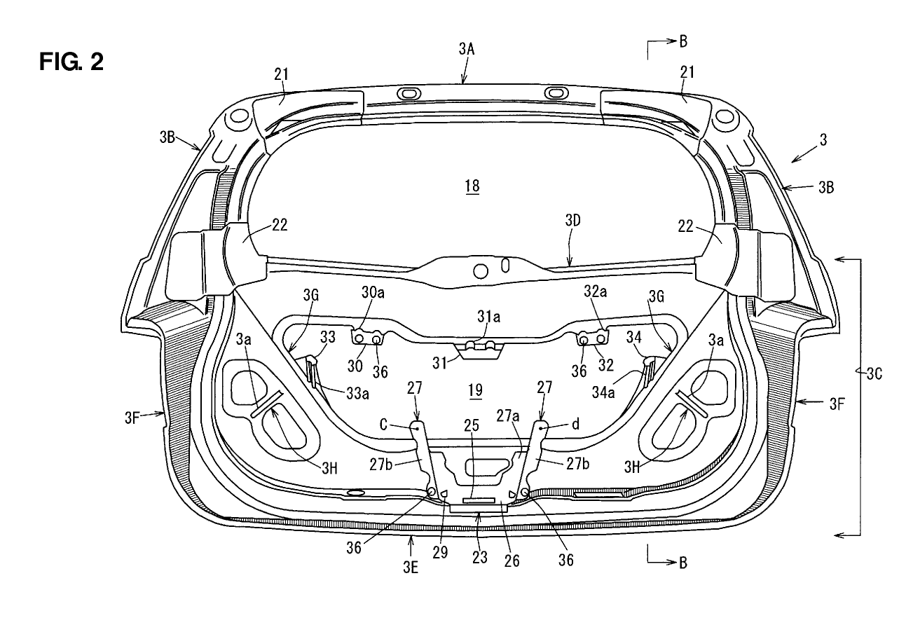

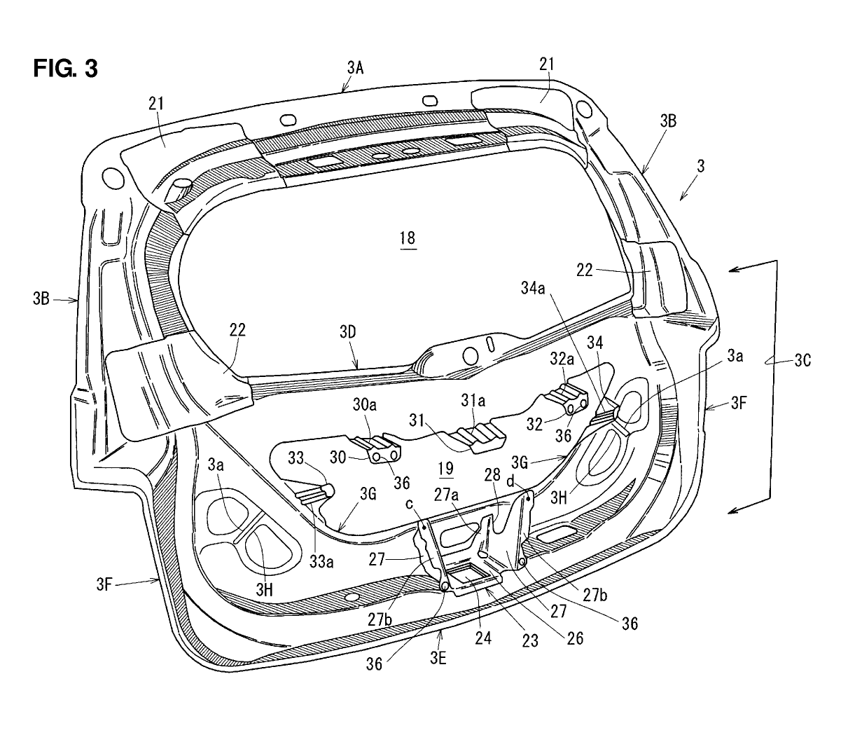

Hereinafter, preferred embodiments of the present invention will be described referring to the accompanying drawings. The figures show a back door structure of a vehicle, and in FIGS. 1, 2 and 3, a back door 1 comprises an outer panel 2 shown in FIG. 1 and an inner panel 3 shown in FIGS. 2 and 3.

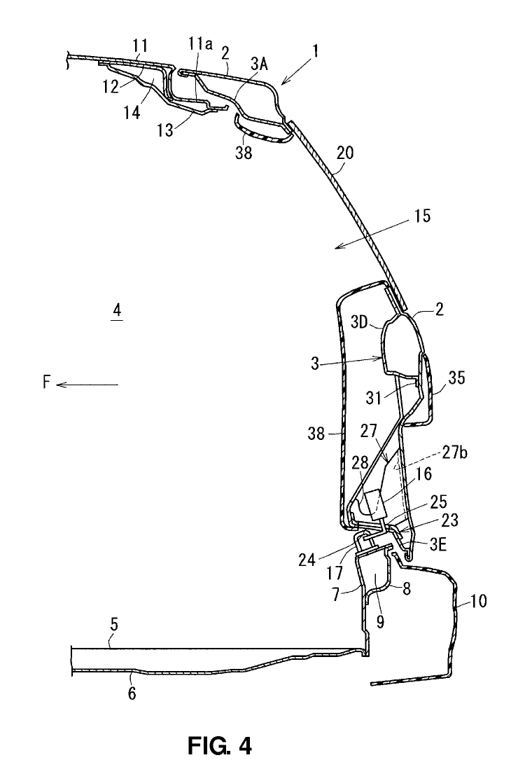

Hereinafter, a structure of a vehicle body will be described in advance of descriptions of a specific structure of the back door 1. As shown in FIG. 4 which is a sectional view taken along line A-A of FIG. 1, a rear floor 5 (floor panel) which forms a floor face of a baggage room 4 is provided, and a spare tire pan 6 is provided at a central portion, in a vehicle width direction, of the rear floor 5 so that it is concaved downwardly. A rear end panel 7 is provided at a rear end portion of the rear floor 5 so that it stands upwardly by a specified height. A rear end member 8 is fixed to a rear side of the rear end panel 7 so that a rear-end closed cross section 9 which extends in the vehicle width direction is formed between the rear end member 8 and the rear end panel 7. This structure with these members 7, 8 improves the rigidity of a lower vehicle body. In FIG. 4, reference numeral 10 denotes a resin-made rear bumper.

Meanwhile, a roof panel 11 as a roof portion covering a vehicle room and the baggage room 4 from above is provided. A roof reinforcement 12 is arranged at a rear end portion of the roof panel 11 on the side of the baggage room 4. A rear header 13 is joined to an inside face (baggage-room-side face) of the roof reinforcement 12. Thus, a header closed cross section 14 which extends in the vehicle width direction is formed between the roof panel 11 and the rear header 13. The rigidity of an upper vehicle body is improved by this structure with these members 11, 12, 13.

An opening portion 15 is formed at a rear wall of the vehicle body, which is closable with the above-described back door 1. The back door 1 rotates around a back door hinge (not illustrated) provided at a step-down portion 11a of the roof panel 11 which corresponds to the header closed cross section 14 so as to open or close the opening portion 15. When the back door 1 is closed, a latch 16 which is provided at a lower portion of the back door 1 engages with a striker 17 which is provided on the side of the vehicle body. Thereby, a closing state of the back door 1 can be secured. Herein, the above-described striker 17 is positioned at an upward bend portion of the rear end panel 7, that is, at a central portion, in the vehicle width direction, of the rear end panel 7 which corresponds to the rear-end closed cross section 9.

Next, a specific structure of the inner panel 3 of the back door 1 will be described referring to FIGS. 2 and 3.

FIG. 2 is a back view of the inner panel 3, and FIG. 3 is a perspective view of the inner panel 3. As shown in FIGS. 2 and 3, the inner panel 3 comprises an upper side portion 3A which forms an upper side of a window opening portion 18, upper side portions 3B, 3B which extend downwardly from both sides of the upper side portion 3A, and a lower half portion 3C which connects to both lower ends of the upper side portions 3B, 3B. The lower half portion 3C includes a middle side portion 3D which forms a lower side of the window opening portion 18 at a middle position, in a vehicle vertical direction, of the back door 1, a lower side portion 3E which forms a lower side of the back door 1, an opening portion 19 which is formed between the middle side portion 3D and the lower side portion 3E, lower side portions 3F, 3F which are provided on both sides of the opening portion 19, slant portions 3G, 3G which connect joint portions between the middle side portion 3D and the lower side portions 3F, 3F to the lower side portion 3E, each of the slant portions 3G, 3G extending obliquely in an elevation view, and connection portions 3H, 3H which connect respective middle portions of the slant portions 3G, 3G to the lower side portions 3F, 3F or the lower side portion 3E. Further, as shown in FIGS. 4 and 1, a back window 20 is arranged at the window opening portion 18.

As shown in FIGS. 2 and 3, hinge reinforcements 21, 21 are fixed to back (rear) faces of both end portions of the upper side portion 3A.

Further, damper reinforcements 22, 22 are fixed to corner portions between the middle side portion 3D and the upper side portions 3B, 3B. Further, a reinforcing member 23 (a so-called latch reinforcement) to reinforce an attachment portion of the latch 16 is provided at a central portion, in the vehicle width direction, of the lower side portion 3E.

As shown in FIG. 3, a latch opening portion 24 is formed at the above-described latch attachment portion of the lower side portion 3E of the inner panel 3 of the back door 1, and the above-described reinforcing member 23 reinforces a periphery of the latch opening portion 24.

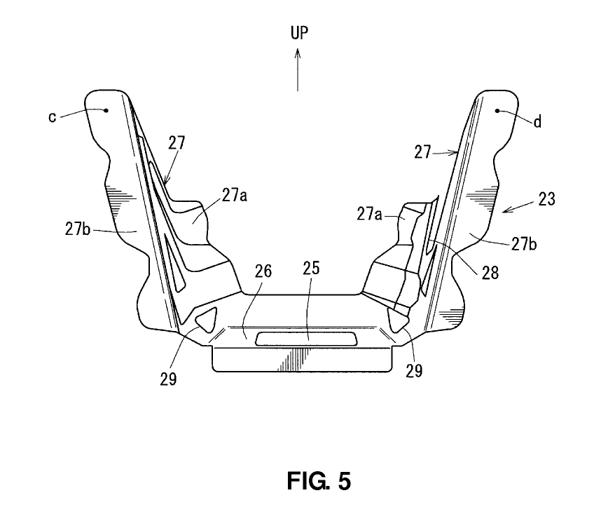

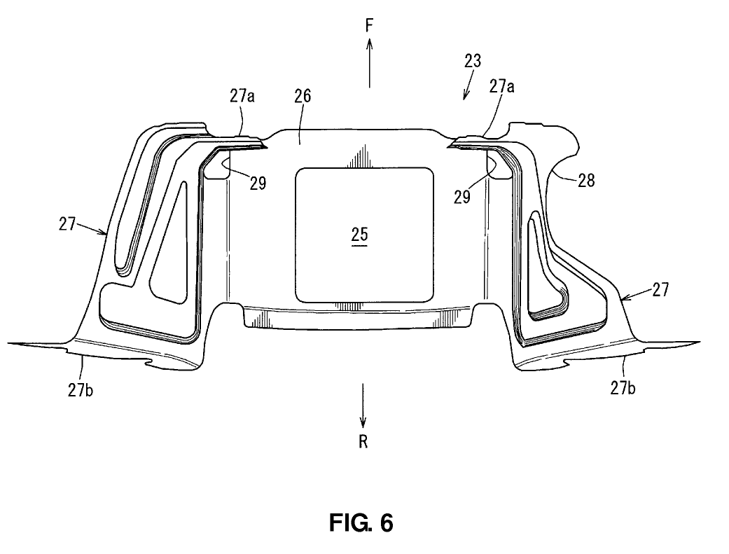

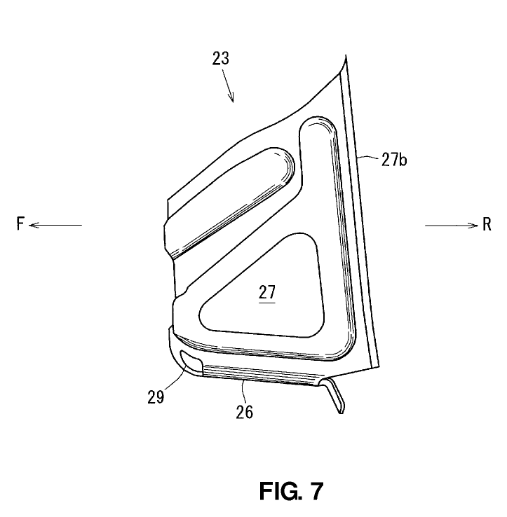

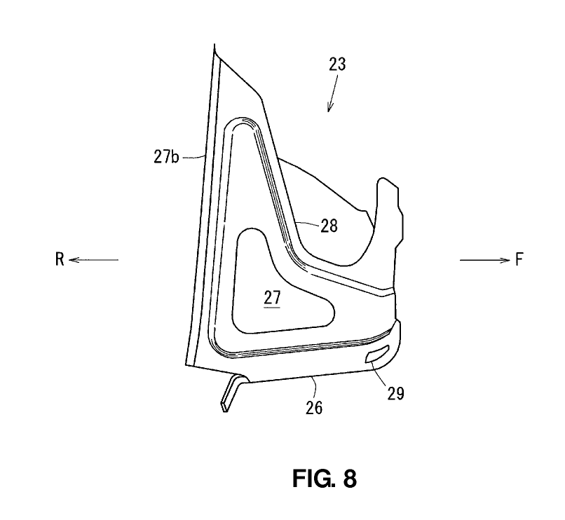

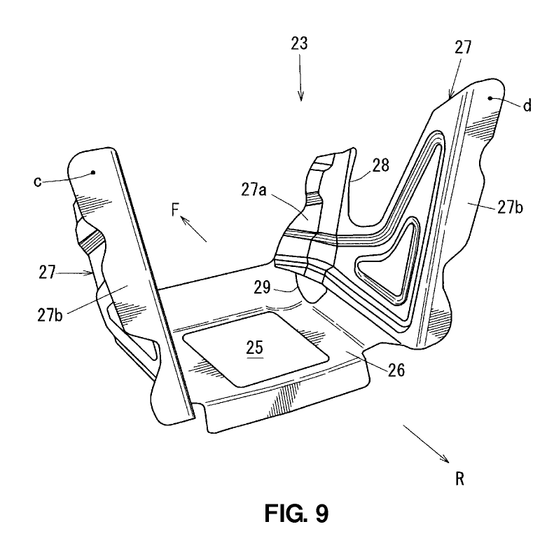

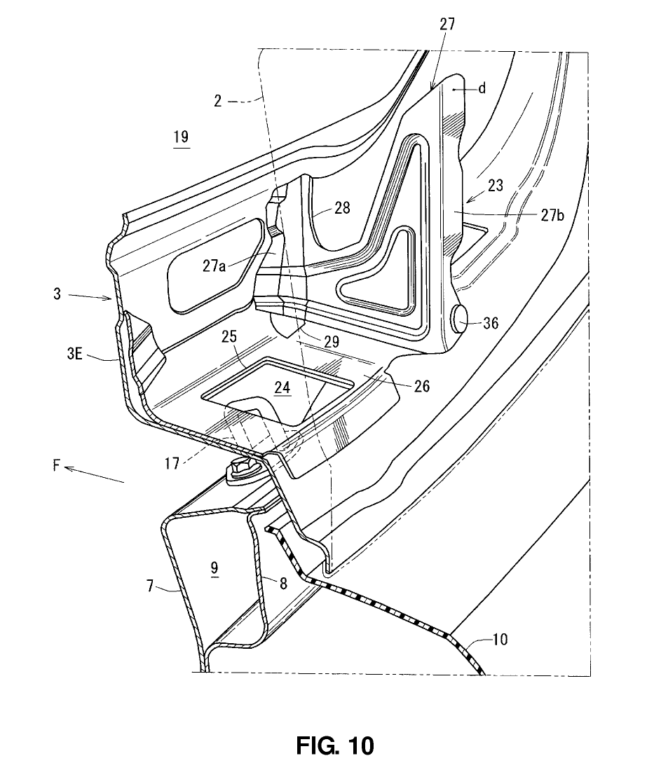

FIG. 5 is a back view of the reinforcing member 23. FIG. 6 is a plan view of the reinforcing member. FIG. 7 is a left side view of FIG. 6. FIG. 8 is a right side view of FIG. 6. FIG. 9 is a perspective view of the reinforcing member. FIG. 10 is a perspective view showing a reinforcement structure by the reinforcing member.

As shown in FIGS. 5 through 10, the reinforcing member 23 comprises a base portion 26 which includes an opening 25 corresponding to the above-described latch opening portion 24 and a pair of side wall portions 27, 27 which is positioned at both sides of the base portion 26 and extends in the vehicle longitudinal direction and connects the inner and outer panels 3, 2. In the present embodiment, as shown in FIGS. 5 through 10, the side wall portions 27, 27 are arranged at both side portions of the reinforcing member 23 so that the latch opening portion 24 (see FIG. 3) is positioned between the side wall portions 27, 27.

Each of the side wall portions 27, 27 integrally includes joint flanges 27a, 27b. The inner-panel-side joint flange 27a (front joint flange) bends inwardly in the vehicle width direction, and the outer-panel-side joint flange 27b (rear joint flange) bends outwardly in the vehicle width direction.

The side wall portions 27, 27 are configured so that the distance therebetween, in the vehicle width direction, becomes greater toward the outer panel 2 in the plan view as shown in FIG. 6. Further, the side wall portions 27, 27 are configured so that the distance therebetween, in the vehicle width direction, becomes greater upwardly in the elevation (back) view.

In case an electromagnetic latch is used as the above-described latch 16, a notch 28 may be formed at the side wall portion 27 on the right side so that a harness extends passing through the notch 28. Further, openings 29, 29 are formed between both ends of a front portion of the base portion 26 and a front lower portion of the side wall portions 27, 27. The base portion 26 of the reinforcing member 23 is fixed, by spot welding, to a periphery of the latch opening portion 24 at the lower side portion 3E of the inner panel 3, the inner-panel-side joint flanges 27a, 27a are fixed, by spot welding, to the inner panel 3, and the outer-panel-side joint flanges 27b, 27b are fixed, by spot welding, to the outer panel 2.

Thus, the above-described reinforcing member 23 connects the inner panel 3 to the outer panel 2. In the present embodiment, the reinforcing member 23 integrally has a pair of side wall portions 27, 27 at its both sides, which extends longitudinally so as to connect the inner and outer panels 3, 2 and covers the above-described latch 16 (see FIG. 4) from side.

Herein, as shown in FIGS. 2 and 3, the above-described middle side portion 3D has plural joint portions 30, 31, 32 which extend rearwardly, that is, toward the outer panel 2, and are joined to the outer panel 2 at its central portion in the vehicle width direction.

The above-described plural joint portions 30, 31, 32 are arranged substantially horizontally in the vehicle width direction. These joint portions 30, 31, 32 include a horizontal portion and a bending portion, respectively. Beads 30a, 31a, 32a are integrally formed at each horizontal portion so that the rigidity of the joint portions themselves can be increased.

Further, as shown in FIGS. 2 and 3, a pair of joint portions 33, 34 is integrally formed at middle portions of the slant portions 3G, 3G (beside the opening portion 19). These joint portions 33, 34 extend rearwardly, that is, toward the outer panel 2 and are joined to this panel 2. These joint portions 33, 34 are arranged substantially horizontally in the vehicle width direction.

Each of the above-described joint portions 33, 34 comprises an extension portion which extends rearwardly and a bending portion at a tip of the extension portion. The respective extension portions include beads 33a, 34a to improve the rigidity of the joint portions 33, 34 themselves. Likewise, the above-described connection portion 3H has a bead 3a to improve the rigidity of the connection portion 3H itself.

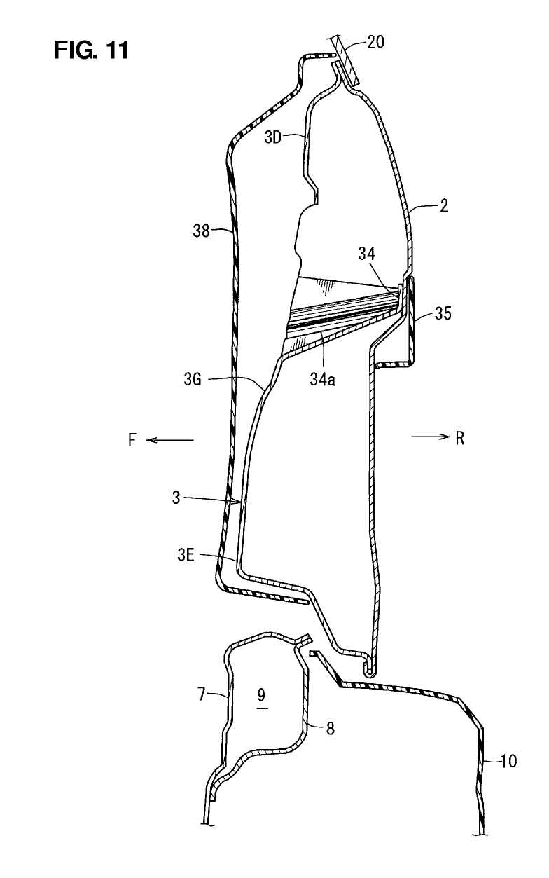

The above-describe joint portions 33, 34 at the slant portions 3G, 3G and the above-describe joint portion 31 at the center of the middle side portion 3D are joined to the outer panel 2 by spot welding as shown in FIGS. 11 and 4, and a garnish 35, as an example of an exterior component, is provided at an outside face of the outer panel 2. The both-side joint portions 30, 32 at the middle side portion 3D are joined to the outer panel 2 by an adhesive 36 (shown by a mark ∘ for convenience).

The outer-panel-side joint flanges 27b, 27b of the side wall portions 27, 27 of the reinforcing member 23 provided at the lower side portion 3E are located at a position which corresponds to a license plate 37 (see FIG. 1), as an exterior component, which is provided at the outside face of the outer panel 2. Upper joint points c, d of the joint flanges 27b, 27b are joined to the outer panel 2 by the spot welding, and lower joint points of the joint flanges 27b, 27b are joined to the outer panel 2 by the adhesive 36 (shown by the mark ∘ for convenience). In the figures, reference numeral 38 denotes a door trim provided at the back door 1 on the side of the baggage room 4. Further, an arrow F shows a vehicle forward direction, an arrow R shows a vehicle rearward direction, and an arrow UP shows a vehicle upward direction.

According to the back door structure of a vehicle of the embodiment described referring to FIGS. 1 through 11, the back door 1 comprises the inner panel 3 and the outer panel 2, the latch 16 is provided at the central portion, in the vehicle width direction, of the lower side portion 3E of the back door 1, the latch opening portion 24 is formed at the latch attachment portion of the lower side portion 3E of the back door 1, the reinforcing member 23 (so-called latch reinforcement) is provided to reinforce the periphery of the latch opening portion 24, and the side wall portions 27, 27 are provided on the side of the reinforcing member, in the vehicle width direction, the side wall portions 27, 27 extending in the vehicle longitudinal direction between the inner and outer panels 3, 2 of the back door 1 and connecting the inner panel 3 to the outer panel 2 (see FIGS. 3, 4 and 10).

According to the above-described structure, the sufficient rigidity can be secured by the above-described side wall portions 27, 27, so that the vibrations and noises can be restrained properly.

Further, the side wall portions 27, 27 are provided on both sides of the reinforcing member 23 so that the latch opening portion 24 is positioned between thereof (see FIG. 3). Thereby, the above-described securing the sufficient rigidity can be properly achieved, so that the vibrations and noises can be further restrained properly.

Moreover, each of the side wall portions 27, 27 includes the inner-panel-side joint flange 27a (front joint flange) and the outer-panel-side joint flange 27b (rear joint flange), the inner-panel-side joint flange 27a bending inwardly in the vehicle width direction, the outer-panel-side joint flange 27b bending outwardly in the vehicle width direction (see FIG. 3). Thereby, the side wall portions 27, 27 can be firmly joined to the inner panel 3 with a properly short span in the vehicle width direction, and the side wall portions 27, 27 can be widely joined to the outer panel 2 with a properly wide span in the vehicle width direction.

Additionally, the side wall portions 27, 27 are configured so that the distance therebetween, in the vehicle width direction, becomes greater toward the outer panel of the back door in the plan view (see FIG. 6). Thereby, the side wall portions 27, 27 can be widely joined to the outer panel 2 with a wide span.

Also, the side wall portions 27, 27 are configured so that the distance therebetween, in the vehicle width direction, becomes greater upwardly in the elevation view (see FIG. 5). Thereby, the side wall portions 27, 27 can be widely joined to a properly-upper portion of the outer panel 2 with a wide span.

Further, the outer-panel-side joint portions 27b, 27b of the side wall portions 27, 27 are joined by welding to the outer panel 2 of the back door 1 at specified positions which correspond to the exterior component (see the license plate 37) provided at the outside face of the outer panel 2 (see FIGS. 1 and 2). Thereby, the sufficiently firm joint can be secured by welding of the outer-panel-side joint portions 27b, 27b of the side wall portions 27, 27 to the outer panel 2, and since welding points are covered with the exterior component (see the license plate 37), good appearances may not be deteriorated. Accordingly, securing both the rigidity and the good appearances can be achieved.

Moreover, the inner panel 3 of the back door 1 comprises the upper side portion 3A which forms the upper side of the window opening portion 18, the upper side portions 3B, 3B which extend downwardly from both sides of the upper side portion 3A, and the lower half portion 3C which connects to both the lower ends of the upper side portions 3B, 3B, and the lower half portion 3C of the inner panel 3 includes the middle side portion 3D which forms the lower side of the window opening portion 18 at the middle position, in the vehicle vertical direction, of the back door 1, the lower side portion 3E which forms the lower side of the back door 1, the opening portion 19 which is formed between the middle side portion 3D and the lower side portion 3E, the lower side portions 3F, 3F which are provided on the both sides of the opening portion 19, and the slant portions 3G, 3G which connect the joint portions between the middle side portion 3D and the lower side portions 3F, 3F to the lower side portion 3F, each of the slant portions 3G, 3G extending obliquely in the elevation view (see FIGS. 2 and 3).

Thereby, the weight of the back door 1 can be properly light by forming the opening portion 19 at the lower half portion 3C of the inner panel 3, and the sufficient rigidity can be secured by the above-described slant portions 3G, 3G and the reinforcing member 23 at the latch attachment portion, so that the vibrations and noises can be restrained properly. Accordingly, both the light weight of the back door 1 and the restraint of vibrations and noises can be achieved.

Also, the middle side portion 3D has the joint portions 30, 31, 32 which extend toward the outer panel 2 and are joined to the outer panel 2 at the central portion thereof in the vehicle width direction (see FIG. 3). Thereby, since the above-described joint portions 30, 31, 32 join the middle side portion 3D of the inner panel 3 to the outer panel 2, the sufficient rigidity of the middle side portion 3D can be secured, so that the vibrations and noises can be restrained properly.

Further, the slant portions 3G, 3G have the joint portions 33, 34 which extend toward the outer panel and are joined to the outer panel 2 (see FIG. 3). Thereby, since the above-described joint portions 33, 34 join the slant portions 3G, 3G to the outer panel 2, the sufficient rigidity of the slant portions 3G, 3G can be secured, so that the vibrations and noises can be restrained properly.

Additionally, the above-described joint portions (the joint portions 30, 31, 32 or the joint portions 33, 34) are arranged substantially horizontally in the vehicle width direction (see FIG. 2). Thereby, the outer panel 2 and the middle side portion 3D, or the outer panel 2 and slant portions 3G, 3G are joined via the joint portions 30, 31, 32 or 33, 34 arranged substantially horizontally in the vehicle width direction, so that securing the sufficient rigidity can be achieved efficiently.

Also, the above-described joint portions 33, 31, 34 are joined to the outer panel 2 by welding, and the exterior component (see the garnish 35) is provided at the outside face of the outer panel 2 (see FIGS. 4 and 11). Thereby, the sufficiently firm joint can be secured by welding of the joint portions 33, 31, 34 to the outer panel 2, and since welding points are covered with the exterior component (see the garnish 35), good appearances may not be deteriorated. Accordingly, securing both the rigidity and the good appearances can be achieved.

Further, the lower half portion 3C further includes the connection portions 3H, 3H which connect the respective middle portions of the slant portions 3G, 3G to the lower side portions 3F, 3F or the lower side portion 3E (see FIGS. 2 and 3). Thereby, since the slant portions 3G, 3G are connected to the lower side portions 3F, 3F or the lower side portion 3E via the connection portions 3H, 3H, the sufficient rigidity of the slant portions 3G, 3G can be secured, so that the vibrations and noises can be restrained properly.

Moreover, the reinforcing member 23 connects the inner panel 3 to the outer panel 2 (see FIG. 10). Thereby, further improvement of the rigidity can be achieved by the reinforcing member 23 connecting the inner panel 3 to the outer panel 2.

Also, the reinforcing member 23 and the side wall portions 27, 27 are formed integrally as a unit (see FIG. 9). Thereby, both reduction of the parts number and costs reduction can be achieved.

Additionally, the side wall portions 27, 27 cover the latch 16 from side (see FIGS. 2 through 4). Thereby, any unauthorized access to the latch is prevented, so that anti-theft structure can be provided. While a releasing lever for the latch 16 is generally provided just in case, for example, a battery is dead and thereby the latch does not work, the side wall portions 27, 27 which are arranged to cover the latch 16 from side can protect against an improper access to the latch 16 via a lamp opening or the like.

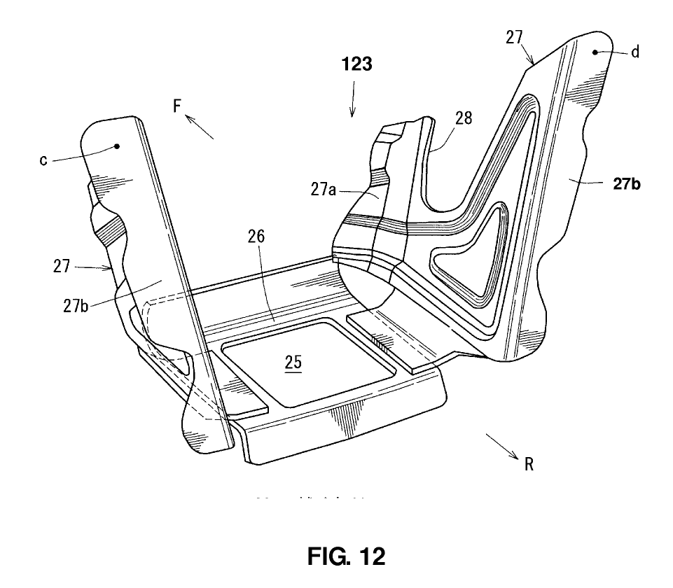

FIG. 12 is a perspective view showing a modification of the reinforcing member (latch reinforcement). While the reinforcing member 23 has the base portion 26 and the side wall portions 27, 27 which are formed integrally in the above-described embodiment shown in FIGS. 5 through 9, according to the modified reinforcing member 123 shown in FIG. 12, the base portion 26 and the side wall portions 27, 27 are firmed separately, and these members are assembled together to constitute the reinforcing member 123. Thereby, since the process of forming the base portion 26 and the side wall portions 27, 27 improve, the reinforcing member 123 which is superior in accuracy of size and the like can be obtained. Herein, the other structures, operations and effects of this reinforcing member 123 are substantially the same as those of the above-described reinforcing member 23, so the same portions are denoted by the same reference characters, specific descriptions are omitted here.

The present invention should not be limited to the above-described embodiments, and any other modifications and improvements may be applied within the scope of a sprit of the present invention.

What is claimed is:

1. A back door structure of a vehicle, comprising:
an inner panel of a back door;
an outer panel of the back door;
a latch provided at a central portion, in a vehicle width direction, of a lower side portion of the back door;
a latch opening portion formed at a latch attachment portion of the lower side portion of the back door;
a reinforcing member provided at the lower side portion of the back door; the reinforcing member reinforcing a periphery of the latch opening portion; and
a side wall portion provided on a side of the reinforcing member, in the vehicle width direction, the side wall portion extending in a vehicle longitudinal direction between the inner and outer panels of the back door and connecting the inner panel to the outer panel.

2. The back door structure of a vehicle of claim 1, wherein said side wall portion comprises a pair of side wall portions which is provided on both sides of the reinforcing member so that said latch opening portion is positioned therebetween.

3. The back door structure of a vehicle of claim 2, wherein each of said side wall portions includes an inner-panel-side joint flange and an outer-panel-side joint flange, the inner-panel-side joint flange bending inwardly in the vehicle width direction, the outer-panel-side joint flange bending outwardly in the vehicle width direction.

4. The back door structure of a vehicle of claim 2, wherein said side wall portions are configured so that a distance therebetween, in the vehicle width direction, becomes greater toward the outer panel of the back door in a plan view.

5. The back door structure of a vehicle of claim 2, wherein said side wall portions are configured so that a distance therebetween, in the vehicle width direction, becomes greater upwardly in an elevation view.

6. The back door structure of a vehicle of claim 3, wherein said outer-panel-side joint portions of the side wall portions are joined by welding to said outer panel of the back door at specified positions which correspond to an exterior component provided at an outside face of the outer panel.

7. The back door structure of a vehicle of claim 1, wherein said inner panel of the back door comprises an upper side portion which forms an upper side of a window opening portion, upper side portions which extend downwardly from both sides of the upper side portion, and a lower half portion which connects to both lower ends of the upper side portions, and the lower half portion of the inner panel includes a middle side portion which forms a lower side of the window opening portion at a middle position, in a vehicle vertical direction, of the back door, said lower side portion which forms a lower side of the back door, an opening portion which is formed between the middle side portion and the lower side portion, lower side portions which are provided on both sides of the opening portion, and slant portions which connect joint portions between the middle side portion and the lower side portions to the lower side portion, each of the slant portions extending obliquely in an elevation view.

8. The back door structure of a vehicle of claim 7, wherein said middle side portion of the lower half portion of the inner panel has joint portions which extend toward the outer panel and are joined to the outer panel at a central portion thereof in the vehicle width direction.

9. The back door structure of a vehicle of claim 7, wherein said slant portions of the lower half portion of the inner panel have joint portions which extend toward the outer panel and are joined to the outer panel.

10. The back door structure of a vehicle of claim 7, wherein said joint portions are arranged substantially horizontally in the vehicle width direction.

11. The back door structure of a vehicle of claim 7, wherein said joint portions are joined to the outer panel by welding, and an exterior component is provided at an outside face of the outer panel.

12. The back door structure of a vehicle of claim 7, wherein said lower half portion of the inner panel further includes connection portions which connect respective middle portions of said slant portions to said lower side portions or said lower side portion.

13. A back door structure of a vehicle, comprising:
an inner panel of a back door;
an outer panel of the back door;
a latch provided at a central portion, in a vehicle width direction, of a lower side portion of the back door; and
a reinforcing member provided at the lower side portion of the back door; the reinforcing member reinforcing an attachment portion of the latch,
wherein said inner panel of the back door comprises an upper side portion which forms an upper side of a window opening portion, upper side portions which extend downwardly from both sides of the upper side portion, and a lower half portion which connects to both lower ends of the upper side portions, and the lower half portion of the inner panel includes a middle side portion which forms a lower side of the window opening portion at a middle position, in a vehicle vertical direction, of the back door, said lower side portion at which said latch and said reinforcing member are provided, an opening portion which is formed between the middle side portion and the lower side portion, lower side portions which are provided on both sides of the opening portion, and slant portions which connect joint portions between the middle side portion and the lower side portions to the lower side portion, each of the slant portions extending obliquely in an elevation view.
